(19) United States
(12) Patent Application Publication
(10) Pub. No.: US 2023/0247050 A1
(43) Pub. Date: Aug. 3, 2023

(54) SYSTEMS AND METHODS FOR SIGNATURE-BASED PHISHING DETECTION BY URL FEED PROCESSING

(71) Applicant: Cloud Linux Software Inc., Estero, FL (US)

(72) Inventors: Igor Seletskiy, Palo Alto, CA (US); Nitin Venkatesh, Chennai (IN)

(21) Appl. No.: 17/591,964

(22) Filed: Feb. 3, 2022

(51) Int. Cl. H04L 9/40

(52) U.S. Cl. CPC H04L 63/1483; H04L 63/1416; H04L 63/1425; H04L 63/20

(57) ABSTRACT

Disclosed herein are systems and method for signature-based phishing detection by URL feed processing. In one aspect, a method includes crawling data from a plurality of web pages, extracting features of the plurality of web pages, and shortlisting, from the extracted features, features that are predominately found in web pages in the plurality of web pages that are classified as phishing pages. The method further includes generating a signature based on a shortlisted feature monitoring a performance of the signature based on a threshold amount of false positives in phishing attack detections generated by the signature on a plurality of devices. In response to determining that the signature has produced less than the threshold amount of false positives, the method includes enabling remediation actions against the potential phishing attacks including the signature.

### FIELD OF TECHNOLOGY

The present disclosure relates to the field of data security, and, more specifically, to systems and methods for signature-based phishing detection by uniform resource locator (URL) feed processing.

### BACKGROUND

There are numerous malicious actors who impersonate legitimate and popular organizations such as banks, social networks, etc., by hosting phishing web pages similar to that of the legitimate organizations to trick users into revealing sensitive information (e.g., login credentials, security numbers, credit card details, etc.). Data security often involves protecting sensitive data through techniques such as encryption to prevent attackers from stealing data. Phishing is especially dangerous because regardless of the level of data protection, the user may unknowingly directly provide the information requested by the malicious actor.

Phishing pages may also be hosted on websites not owned by the malicious actor—but compromised by them. This could lead to a website being flagged as “malicious” or “phishing” by security tools such as Google Safe Browsing, and may negatively affect reputation, credibility, the website's search engine ranking, organization revenue, etc.

Since the threat landscape is constantly changing, sometimes minor variations in the phishing pages could result in a loss of their detection by security tools. Likewise, some legitimate websites may be incorrectly labelled as phishing pages due to false positive detections. There thus exists a need for an effective phishing detection system.

### SUMMARY

The present disclosure describes an approach to phishing detection in which threat feeds and user submissions are processed to automatically generate signatures for targeting potential phishing pages. Upon detection and analysis, actions such as quarantining and deletion can be executed. Aspects of the disclosure thus specifically describe methods and systems for signature-based phishing detection by uniform resource locator (URL) feed processing.

In some aspects, the techniques described herein relate to a method for signature generation for phishing attack detection, the method including: crawling data from a plurality of web pages, each web page hosted at a uniform resource locator (URL); extracting features of the plurality of web pages from the crawled data; shortlisting, from the extracted features, features that are predominately found in web pages in the plurality of web pages that are classified as phishing pages; generating a signature based on a shortlisted feature, wherein the signature is included in a monitoring mode in which remediation actions cannot be taken against potential phishing attacks including the signature; transmitting the signature to a plurality of devices including agents configured to determine whether files on a local file system of each device are involved with phishing attacks based on detection of the signature; monitoring a performance of the signature based on a threshold amount of false positives in phishing attack detections generated by the signature on the plurality of devices; and in response to determining that the signature has produced less than the threshold amount of false positives, transmitting a command to each of the plurality of devices to enter the signature in an active mode in which remediation actions can be taken against the potential phishing attacks including the signature.

In some aspects, the techniques described herein relate to a method, wherein monitoring the performance of the signature further includes: receiving a first number of indications from the plurality of devices that features in scanned files correspond to the signature, suggesting that the scanned files are involved in phishing attacks; confirming that the features in the scanned files correspond to the signature; recording each indication received in a statistics database; receiving a second number of indications from the plurality of devices that the scanned files are not involved in phishing attacks; determining an amount of false positives as a ratio of the second number and the first number for comparison with the threshold amount of false positives.

In some aspects, the techniques described herein relate to a method, wherein the agents in the plurality of devices generate additional signatures in the monitoring mode, further including: synchronizing signatures across the plurality of devices, wherein each respective signature includes an indication of whether the respective signature is in the monitoring mode or in the active mode.

In some aspects, the techniques described herein relate to a method, wherein the agents are configured to execute a remediation action on a file that includes a threshold number of signatures in the active mode.

In some aspects, the techniques described herein relate to a method, further including: in response to determining that the signature has not produced less than the threshold amount of false positives, deleting the signature.

In some aspects, the techniques described herein relate to a method, wherein shortlisting, from the extracted features, the features that are predominately found in web pages in the plurality of web pages that are classified as phishing pages further includes: identifying a given feature that is in a web page classified as a phishing page; determining whether the given feature is present in at least a first threshold amount of the phishing pages; determining whether the given feature is detectable by an existing signature; determining whether the given feature is present in less than a second threshold amount of web pages that are not classified as the phishing pages; and shortlisting the given feature if the given feature is (1) present in at least the first threshold amount of the phishing pages, (2) is not detectable by an existing signature, and (3) is present in less than the second threshold amount of web pages that are not classified as the phishing pages.

In some aspects, the techniques described herein relate to a method, wherein classifying the web page as the phishing page includes executing a machine learning algorithm configured to determine whether a given web page is a phishing page.

In some aspects, the techniques described herein relate to a method, wherein the machine learning algorithm is re-trained periodically with new input vectors including features from known phishing pages.

It should be noted that the methods described above may be implemented in a system comprising a hardware processor. Alternatively, the methods may be implemented using computer executable instructions of a non-transitory computer readable medium.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for signature-based phishing detection by uniform resource locator (URL) feed processing.

FIG. 2 is a block diagram illustrating a system for achieving herd immunity with shortlisted signatures.

FIG. 3 illustrates a flow diagram of a method for signature-based phishing detection by URL feed processing.

FIG. 4 is a flow diagram illustrating a method for shortlisting features.

FIG. 5 presents an example of a general-purpose computer system on which aspects of the present disclosure can be implemented.

### DETAILED DESCRIPTION

Exemplary aspects are described herein in the context of a system, method, and computer program product for signature-based phishing detection by uniform resource locator (URL) feed processing. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

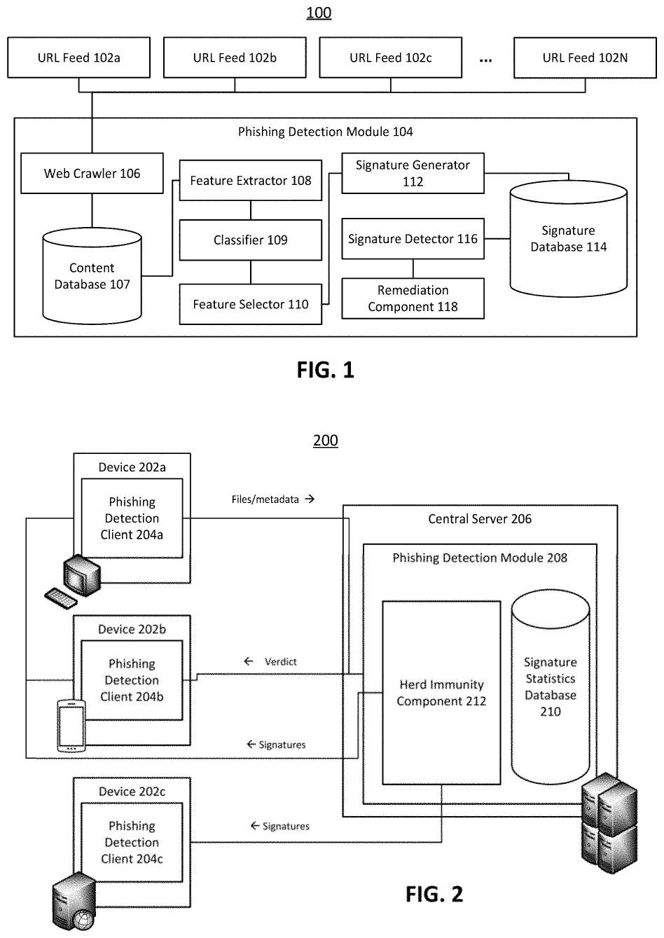

FIG. 1 is block diagram 100 illustrating a system for signature-based phishing detection by uniform resource locator (URL) feed processing. In diagram 100, phishing detection module 104 is depicted. In some aspects, phishing detection module 104 is a standalone software application configured to detect and block phishing web pages from generating, collecting, and/or transmitting user information. In some aspects, phishing detection module 104 is part of a system firewall or an anti-virus software application. Phishing detection module 104 includes a plurality of components including: web crawler 106, feature extractor 108, feature selector 110, signature generator 112, signature database 114, signature detector 116, and remediation component 118.

Web crawler 106 is configured to crawl (i.e., extract) content in URL feeds 102 (e.g., feeds 102a, feed 102b, feed 102c, . . . 102N), which are regularly-updated lists/data that are accessible using a non-frequently changed address or is provided to phishing detection module 104 in batches at periodic intervals. In some aspects, the feeds are from internal sources, third-party vendors, or user submissions. Web crawler 106 stores the crawled contents of the web-pages in content database 107 temporarily for analysis. In some aspects, the contents of the web pages are deleted after analysis by feature extractor 108.

Feature extractor 108 analyzes the contents in content database 107 and extracts features that are strong indicators of phishing. For example, feature extractor 108 may extract the content of HTML <title> tags or the copyright information mentioned on the web pages. This extracted content may help in identifying a brand or organization and/or some phrases that may be indicative of the feature being potentially used in phishing campaigns.

### Example

<title> XYZ Bank—Login/Sign up </title>
© 2021. All rights reserved, XYZ Bank.

Based on the quality of the data crawled for each feature, feature selector 110 shortlists specific features for signature creation. For example,
<title> XYZ Bank—Login/Sign up </title> #
   has a higher likelihood of being shortlisted as it is more likely to be used in phishing campaigns (i.e., may show up in known phishing web pages), while
<title> XYZ Blog </title> #
   has a very low likelihood of being shortlisted as it is not very likely to be used in phishing campaigns. The likelihood can be determined using techniques, including, but not limited to heuristics and machine learning. For example, classifier 109 may be a Naive-Bayes classifier trained on previously (manually/automatically) classified phishing web pages.

For example, classifier 109 may be trained on a plurality of pages that are marked as “phishing” or “non-phishing.” Suppose that the training dataset is organized as follows:

Training Dataset

| | | | | | |
|---|---|---|---|---|---|
| Page A | Feature 1 | Feature 2 | Feature 3 | Feature 10 | Non-Phishing |
| Page B | Feature 100 | Feature 4 | Feature 12 | Feature 11 | Phishing |
| Page C | Feature 18 | Feature 4 | Feature 12 | Feature 75 | Phishing |
| Page D | Feature 4 | Feature 12 | Feature 3 | Feature 99 | Phishing |

As can be seen, features 4 and 12 are present in all three of the phishing web pages. Feature 4 may be for example <title> XYZ Bank—Login/Sign up </title>. The numbers assigned to the features such as “4” and “12” are simply there to distinguish between the features of each page. Furthermore, there may be any number of features extracted for each page, but only four features per page are shown for simplicity. Classifier 109 may be trained to identify pages with features 4 and/or 12 as “phishing” pages. By default, signature database 114 may include signatures for tracking features 4 and 12. However, phishing attacks are constantly evolving to avoid detection. Thus, not all pages will include features 4 and 12 and classifier 109 may be re-trained to keep up with the changes in phishing attacks. In one setup, new attacks may be registered manually. For example, if a novel phishing attack is known to have damaged a device or stolen information, the features of the phishing attack may be extracted and structured in a training vector as shown below:

| | | | | | |
|---|---|---|---|---|---|
| Page E | Feature 98 | Feature 7 | Feature 4 | Feature 101 | Phishing |

The approach of re-training classifier 109 only when a phishing page is successful in its attack is reactive—not preventative. A preventative approach is also needed to prevent unnecessary damage and involves analyzing features that appear to be associated with a phishing attack. For example, subsequent to feature extractor 108 extracting features from URL feeds 102, feature selector 110 may generate a combination of input vectors (e.g., one vector for each crawled page) comprising the features to determine which pages are classified as “phishing” by classifier 109. Suppose that the input vectors generated from the extracted features are:

| | | | | |
|---|---|---|---|---|
| Page F | Feature 1 | Feature 4 | Feature 12 | Feature 94 |
| Page G | Feature 94 | Feature 3 | Feature 1 | Feature 21 |

In this case, both vectors include features (e.g., 1, 3, 4, 12) that are present in phishing pages, and classifier 109 may classify both as “phishing.” In addition, both vectors include feature 94, which may be a new feature in phishing attacks. The preventative approach involves generating a signature of feature 94, so that phishing attacks with this feature can automatically be detected before they steal information or do damage to a user device. An example of a phishing feature (e.g., feature 94) may be the usage of a homoglyph or homograph in a brand name. For example:
paypal (mostly Cyrillic), HTML encoding translates to: &rcy;&acy;&ucy;&rcy;&acy;&#108;
9paypal (Latin), HTML encoding translates to: &#112;&#97;&#121;&#112;&#97;&#108;
Although they look very similar to each other visually, they are entirely different strings and this is an evasion technique deployed in phishing campaigns.

On a technical level, subsequent to classifier 109 determining that both input vectors are “phishing,” feature selector 110 analyzes the features in the input vectors and shortlists features that are (1) present in at least a first threshold amount of input vectors collected over a period of time, (2) do not correspond to signatures in signature database 114, and/or (3) are not present in more than a second threshold amount of “non-phishing” vectors in the training dataset. For (1), the objective is to identify reoccurring features such as feature 94. Suppose that the first threshold amount is set to 50% and the period of time is one week. Feature selector 110 may initially shortlist features that are present in at least half of the input vectors that are generated by feature extractor 108 for content collected during the week. For (2), the objective is to ensure that the feature is novel. For example, feature selector 110 may determine whether the feature would be detected by any of the signatures already present in signature database 114. If none of the signatures are able to detect the feature, then there is more of a reason to generate a new signature for the feature. For (3), the objective is to reduce false positives by ensuring that the feature is predominately present in “phishing” pages only and not “non-phishing” pages. Suppose that the second threshold amount is 10%. If more than 10% of “non-phishing” vectors include the feature, feature selector 110 may not shortlist the feature to avoid “non-phishing” pages from being classified as false positive “phishing” pages.

Signature generator 112 then creates signatures for the shortlisted features. These signatures may be in a form suitable to the tool used for scanning files, including, but not limited to ClamAV, YARA, custom bash/PHP/Perl scripts. The files may be present in the webroot or other locations on the filesystem and include PHP scripts, HTML files, plain text files, etc. In some aspects, signature generation by signature generator 112 involves the normalization of text in the shortlisted features. Normalization may include, but is not limited to, decoding/encoding content, consistent casing, flattening homoglyphs to relatable ASCII characters, etc., to create signatures with better coverage. For example, the signature for the feature
<title> XYZ Bank—Login/Sign up </title> #
   may be:
<title>\s*XYZ\s*Bank\s*\-\s*Login\s*/\s*Sign\s*up\s*</title>
   Signature generator 112 stores all generated signatures in signature database 114.

Signature detector 116 evaluates a file to determine if the file is involved in a phishing attack (e.g., is triggering the attack or is a component of the attack). The determination of a file being malicious or not can be achieved using a number of features extracted from the file as well as its metadata. Signature detector 116 then determines whether at least one of the phishing signatures in signature database 114 match any of the extracted features of the file. Examples of such features include, but are not limited to, the associated web URL (e.g., https://example.org/dir1/subdir1/subdir2/filename.html), a location of the file (e.g., the directory path of the file relative to the web root such as /var/www/html/dir1/subdir1/subdir2/filename.html), a location of the file relative to the web root (e.g., /dir1/subdir1/subdir2/filename.html), domains present in the file (e.g., www.example.org), and a multipurpose Internet mail extension (MIME) type of the file (e.g., text/html, text/plain, etc.). Signature detector 116 may identify a file as being involved in a phishing attack if more than a third threshold number of signature matches are found. For example, if the third threshold number is 10 and more than 10 signatures are found in a file, signature detector 116 may conclude that the file is involved in a phishing attack.

In an exemplary aspect, in response to detecting that a file is involved in a phishing attack, remediation component 118 may perform a remediation action that prevents the file from harming the device, collecting any information, or transmitting collected information. Examples of remediation actions include, but are not limited to, isolating the file in quarantine, removing the file, or changing the contents of the file (e.g., code in a script) so that the purpose of the file is not accomplished.

In some aspects, the signatures created are initially launched in a monitoring mode to only detect and collect information about detected files, but not take any action against the detected files. Monitoring module may last for a set period of time (e.g., 1 week), or may be set for a threshold amount of times that the signature is activated (e.g., the signature needs to be activated at least 50 times before it comes out of monitoring mode). This is to prevent false positives from affecting the performance of a device or web page. For example, if a web page is authentic and remediation component 118 prevents access to the web page, the user will be dissatisfied by the performance of phishing detection module 104. One way to ensure that a signature is effective is by monitoring the detection of the signature across multiple devices.

FIG. 2 is block diagram 200 illustrating a system for achieving herd immunity with shortlisted signatures. In some aspects, analysis of the files in monitoring mode may be performed solely on the client-side by an agent module that has the technical capabilities to analyze built-in along with scanning capabilities (e.g., phishing detection module 104). In other aspects, during monitoring mode, file data and metadata may be transmitted to a central server (e.g., central server 206) or a group of servers (e.g., the cloud) to provide verdicts in near real-time and/or to store the data to perform additional analyses on the samples from a plurality of user devices (e.g., devices 202. Diagram 200 presents such an aspect.

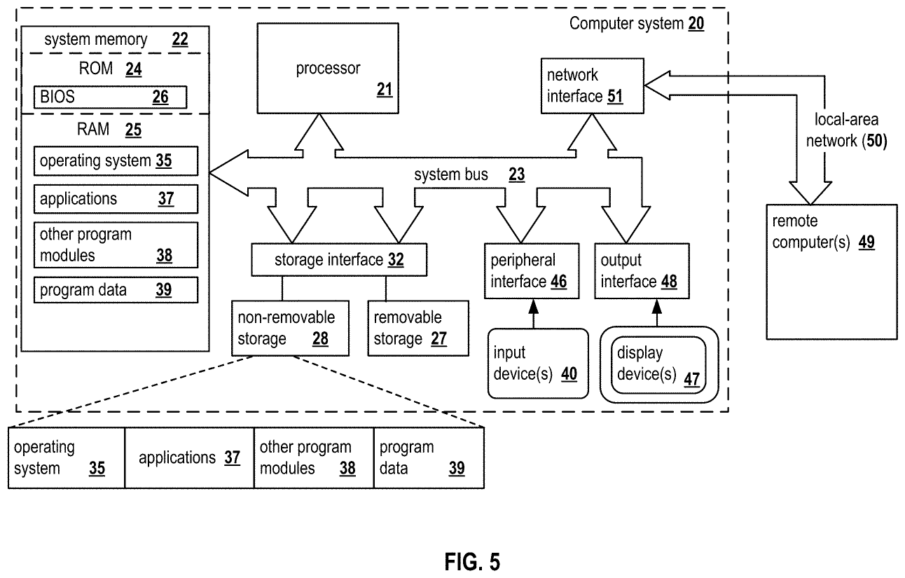

In diagram 200, three devices 202 are shown (e.g., device 202a, device 202b, device 202c) for simplicity. One skilled in the art will appreciate that there may be any number of devices connected to central server 206 (which may include one or more servers in a data center). Devices 202 may be any device described in FIG. 5. For example, device 202a may be a computer, device 202b may be a smartphone, and device 202c may be a server. A phishing detection client may be installed on each device. Consider device 202a for the following example. For any given file, feature extractor 108 on phishing detection client 204a may extract features from the data and/or metadata of the file and determine whether the features correspond to a signature in monitoring mode (e.g., a signature that has been recently created and is being observed for its effectiveness in detecting phishing attacks). If the file corresponds to a signature that is not being monitored for effectiveness, remediation component 118 may block the phishing attack associated with the file using a remediation action.

However, if the file features correspond to a signature in monitoring mode, phishing detection client 204a may transmit the features to phishing detection module 208, which is equivalent to phishing detection module 104 described previously. In some aspects, phishing detection client 204a may simply transmit the file and its metadata to phishing detection module 208 so that feature extractor 108 on module 208 may extract the features. Signature detector 116 on phishing detection module 208 may affirm that the features correspond to a signature in monitoring mode, and may transmit the verdict back to phishing detection client 204a.

The verdicts on the detected files are also stored in signature statistics database 210 to gather some metrics on each of the signatures over a period of time which could be in the range of a few days to a few weeks. The efficiency of each signature in monitoring mode (only detection) is checked by herd immunity component 212 periodically within a time-window (e.g., every week for 6 weeks). By using predefined threshold values (e.g., less than 2 false-positives in a week) or rules with conditional logic (e.g., less than 2 false-positives in a week AND total detections greater than 10 in the same week) it becomes possible for herd immunity component 212 to filter out signatures that have not performed so well and disable them. At the same time, the signatures that did perform well are switched to active mode from monitoring mode, allowing clients 204 to take remediation actions on the files that get detected when scanned (e.g., deletion, quarantine, etc.). By following the above method, URL feeds/user-submitted URLs suspected of phishing can be processed to produce signatures automatically and also test and evaluate their performance before safely putting them to active use automatically.

In some aspects, clients 204a, 204b, and 204c generate their own signatures based on the feeds they crawl. These signatures are marked as monitoring mode signatures and are sent to phishing detection module 208. Herd immunity component 212 synchronizes all signature databases on each device 202 and central server 206. As the performance of signatures in monitoring mode is evaluated by herd immunity component 212, certain signatures may prove to be effective. For example, a first signature may be detected a threshold number of time (e.g., 10 times) and in at least a threshold amount of cases (e.g., 9 times), the remediation action may successfully prevent the phishing attack from being carried out successfully. Based on this criteria being fulfilled, herd immunity component 212 may transmit a command to each of the phishing detection clients 204 that the first signature has entered active mode. At this point, if the first signature is detected, and a file is deemed being involved in a phishing attack by a client 204, the client may take a remediation action.

In some cases, a signature may be ineffective. For example, upon detection of the signature, client 204a may generate an alert on device 202a that the file may be associated with a phishing attack. If in at least a threshold amount of cases (e.g., 3 times out of 10) a user indicates that the file is not associated with a phishing attack across all devices, herd immunity component 212 may transmit a command to each client 204 that the signature should be removed from signature database 114.

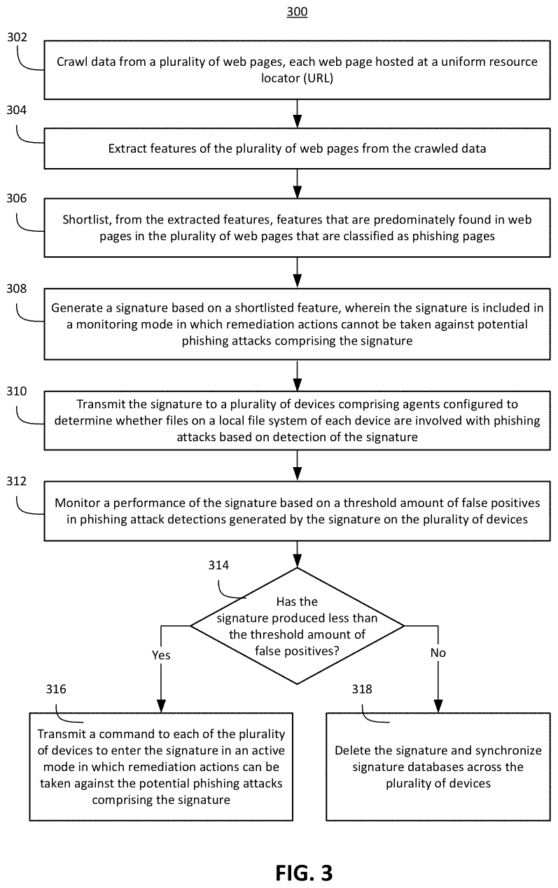

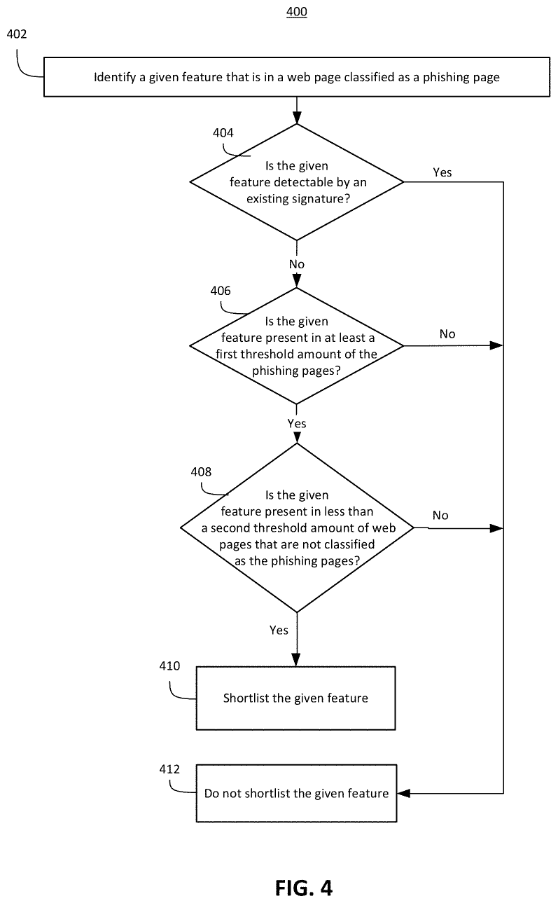

FIG. 3 illustrates a flow diagram of method 300 for signature-based phishing detection by URL feed processing. At 302, web crawler 106 crawls data from a plurality of web pages, where each web page is hosted at a uniform resource locator (URL). At 304, feature extractor 108 extracts features of the plurality of web pages from the crawled data. At 306, feature selector 110 shortlists, from the extracted features, features that are predominately found in web pages in the plurality of web pages that are classified as phishing pages. An example of shortlisting is described in FIG. 4.

At 308, signature generator 112 generates a signature based on a shortlisted feature, wherein the signature is included in a monitoring mode in which remediation actions cannot be taken against potential phishing attacks comprising the signature. At 310, phishing detection module 208 transmits the signature to a plurality of devices (e.g., devices 202a, 202b, 202c) comprising agents (e.g., phishing detection clients 204) configured to determine whether files on a local file system of each device are involved with phishing attacks based on detection of the signature. In some aspects, the agents are configured to execute a remediation action on a file that includes a threshold number of signatures in the active mode. In some aspects, the agents generate additional signatures in the monitoring mode and herd immunity component 212 synchronizes signatures across the plurality of devices, wherein each respective signature includes an indication of whether the respective signature is in the monitoring mode or in the active mode.

At 312, herd immunity component 212 monitors a performance of the signature based on a threshold amount of false positives in phishing attack detections generated by the signature on the plurality of devices. In some aspects, the performance is evaluated over a set period of time (e.g., 1 week) that is enough to query whether the signature has been detected over the plurality of devices. In some aspects, during monitoring, herd immunity component 212 receives a first number of indications (e.g., 100) from the plurality of devices that features in scanned files correspond to the signature, suggesting that the scanned files are involved in phishing attacks. Phishing detection module 208 confirms that the features in the scanned files correspond to the signature (e.g., using signature detector 116). Phishing detection module 208 records each indication received in a statistics database (e.g., signature statistics database 210). Herd immunity component 212 then receives a second number of indications (e.g., 5) from the plurality of devices that the scanned files are not involved in phishing attacks. Herd immunity component 212 determines an amount of false positives as a ratio of the second number and the first number for comparison with the threshold amount of false positives. For example, the ratio may be 5/100, which is 5%. The threshold amount of false positives may be 10%.

At 314, herd immunity component 212 determines whether the signature has produced less than the threshold amount of false positives (e.g., 5% is less than 10%). In response to determining that the signature has produced less than the threshold amount of false positives, method 300 advances to 316, where herd immunity component 212 transmits a command to each of the plurality of devices to enter the signature in an active mode in which remediation actions can be taken against the potential phishing attacks comprising the signature. This is because the signature has successfully identified phishing attacks with minimal false positives.

However, in response to determining that the signature has not produced less than the threshold amount of false positives (e.g., if the threshold amount was 2%), method 300 advances to 318, where herd immunity component 212 deletes the signature (e.g., from signature database 114) and synchronizes signature databases across the plurality of devices. It should be noted that the sensitivity of phishing detection module 208 is dictated by the threshold values described in the present disclosure. These threshold values may be adjusted by the user of a device or by the developer of phishing detection module 208.

FIG. 4 is a flow diagram illustrating method 400 for shortlisting features. At 402, feature selector 110 identifies a given feature that is in a web page classified as a phishing page. In some aspects, classifying the web page as the phishing page comprises executing a machine learning algorithm (e.g., classifier 109) configured to determine whether a given web page is a phishing page. In some aspects, the machine learning algorithm is re-trained periodically with new input vectors comprising features from known phishing pages.

Blocks 404, 406, and 408 may be queried in any order, but for simplicity are organized in the manner shown in FIG. 4. At 404, feature selector 110 determines whether the given feature is detectable by an existing signature. If the given feature is detectable by an existing signature, there is no need to shortlist the feature as doing so will cause redundancy and method 400 advances to 412 where feature selector 110 does not shortlist the feature. If the given feature is not detectable by an existing signature, method 400 advances to 406, where feature selector 110 determines whether the given feature is present in at least a first threshold amount of phishing pages. If the given feature is present in at least the first threshold amount of phishing pages, method 400 advances to 408, where feature selector 110 determines whether the given feature is present in less than a second threshold amount of web pages that are not classified as phishing pages. If the given feature is present in less than a second threshold amount of non-phishing pages, method 400 advances to 410, where feature selector 110 shortlists the given feature. If feature selector 110 determines the negative in 406 or 408, method 400 advances to 412.

FIG. 5 is a block diagram illustrating a computer system 20 on which aspects of systems and methods for signature-based phishing detection by URL feed processing may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-4 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for signature generation for phishing attack detection, the method comprising:
crawling data from a plurality of web pages, each web page hosted at a uniform resource locator (URL);
extracting features of the plurality of web pages from the crawled data;
shortlisting, from the extracted features, features that are predominately found in web pages in the plurality of web pages that are classified as phishing pages;
generating a signature based on a shortlisted feature, wherein the signature is included in a monitoring mode in which remediation actions cannot be taken against potential phishing attacks comprising the signature;
transmitting the signature to a plurality of devices comprising agents configured to determine whether files on a local file system of each device are involved with phishing attacks based on detection of the signature;
monitoring a performance of the signature based on a threshold amount of false positives in phishing attack detections generated by the signature on the plurality of devices; and
in response to determining that the signature has produced less than the threshold amount of false positives, transmitting a command to each of the plurality of devices to enter the signature in an active mode in which remediation actions can be taken against the potential phishing attacks comprising the signature.

2. The method of claim 1, wherein monitoring the performance of the signature further comprises:
receiving a first number of indications from the plurality of devices that features in scanned files correspond to the signature, suggesting that the scanned files are involved in phishing attacks;
confirming that the features in the scanned files correspond to the signature;
recording each indication received in a statistics database;
receiving a second number of indications from the plurality of devices that the scanned files are not involved in phishing attacks;
determining an amount of false positives as a ratio of the second number and the first number for comparison with the threshold amount of false positives.

3. The method of claim 1, wherein the agents in the plurality of devices generate additional signatures in the monitoring mode, further comprising:
synchronizing signatures across the plurality of devices, wherein each respective signature includes an indication of whether the respective signature is in the monitoring mode or in the active mode.

4. The method of claim 1, wherein the agents are configured to execute a remediation action on a file that includes a threshold number of signatures in the active mode.

5. The method of claim 1, further comprising:
in response to determining that the signature has not produced less than the threshold amount of false positives, deleting the signature.

6. The method of claim 1, wherein shortlisting, from the extracted features, the features that are predominately found in web pages in the plurality of web pages that are classified as phishing pages further comprises:
identifying a given feature that is in a web page classified as a phishing page;
determining whether the given feature is present in at least a first threshold amount of the phishing pages;
determining whether the given feature is detectable by an existing signature;
determining whether the given feature is present in less than a second threshold amount of web pages that are not classified as the phishing pages; and
shortlisting the given feature if the given feature is (1) present in at least the first threshold amount of the phishing pages, (2) is not detectable by an existing signature, and (3) is present in less than the second threshold amount of web pages that are not classified as the phishing pages.

7. The method of claim 6, wherein classifying the web page as the phishing page comprises executing a machine learning algorithm configured to determine whether a given web page is a phishing page.

8. The method of claim 7, wherein the machine learning algorithm is re-trained periodically with new input vectors comprising features from known phishing pages.

9. A system for signature generation for phishing attack detection, comprising:
a memory; and
a hardware processor communicatively coupled with the memory and configured to:
crawl data from a plurality of web pages, each web page hosted at a uniform resource locator (URL);
extract features of the plurality of web pages from the crawled data;
shortlist, from the extracted features, features that are predominately found in web pages in the plurality of web pages that are classified as phishing pages;
generate a signature based on a shortlisted feature, wherein the signature is included in a monitoring mode in which remediation actions cannot be taken against potential phishing attacks comprising the signature;
transmit the signature to a plurality of devices comprising agents configured to determine whether files on a local file system of each device are involved with phishing attacks based on detection of the signature;
monitor a performance of the signature based on a threshold amount of false positives in phishing attack detections generated by the signature on the plurality of devices; and
in response to determining that the signature has produced less than the threshold amount of false positives, transmit a command to each of the plurality of devices to enter the signature in an active mode in which remediation actions can be taken against the potential phishing attacks comprising the signature.

10. The system of claim 9, wherein the hardware processor is further configured to monitor the performance of the signature by:
receiving a first number of indications from the plurality of devices that features in scanned files correspond to the signature, suggesting that the scanned files are involved in phishing attacks;
confirming that the features in the scanned files correspond to the signature;
recording each indication received in a statistics database;
receiving a second number of indications from the plurality of devices that the scanned files are not involved in phishing attacks;
determining an amount of false positives as a ratio of the second number and the first number for comparison with the threshold amount of false positives.

11. The system of claim 9, wherein the agents in the plurality of devices generate additional signatures in the monitoring mode, and wherein the hardware processor is further configured to:
synchronizing signatures across the plurality of devices, wherein each respective signature includes an indication of whether the respective signature is in the monitoring mode or in the active mode.

12. The system of claim 9, wherein the agents are configured to execute a remediation action on a file that includes a threshold number of signatures in the active mode.

13. The system of claim 9, wherein the hardware processor is further configured to:
in response to determining that the signature has not produced less than the threshold amount of false positives, delete the signature.

14. The system of claim 9, wherein the hardware processor is further configured to shortlist, from the extracted features, the features that are predominately found in web pages in the plurality of web pages that are classified as phishing pages by:
identifying a given feature that is in a web page classified as a phishing page;
determining whether the given feature is present in at least a first threshold amount of the phishing pages;
determining whether the given feature is detectable by an existing signature;
determining whether the given feature is present in less than a second threshold amount of web pages that are not classified as the phishing pages; and
shortlisting the given feature if the given feature is (1) present in at least the first threshold amount of the phishing pages, (2) is not detectable by an existing signature, and (3) is present in less than the second threshold amount of web pages that are not classified as the phishing pages.

15. The system of claim 14, wherein the hardware processor is further configured to classify the web page as the phishing page by executing a machine learning algorithm configured to determine whether a given web page is a phishing page.

16. The system of claim 15, wherein the machine learning algorithm is re-trained periodically with new input vectors comprising features from known phishing pages.

17. A non-transitory computer readable medium storing thereon computer executable instructions for signature generation for phishing attack detection, including instructions for:
crawling data from a plurality of web pages, each web page hosted at a uniform resource locator (URL);
extracting features of the plurality of web pages from the crawled data;
shortlisting, from the extracted features, features that are predominately found in web pages in the plurality of web pages that are classified as phishing pages;
generating a signature based on a shortlisted feature, wherein the signature is included in a monitoring mode in which remediation actions cannot be taken against potential phishing attacks comprising the signature;
transmitting the signature to a plurality of devices comprising agents configured to determine whether files on a local file system of each device are involved with phishing attacks based on detection of the signature;
monitoring a performance of the signature based on a threshold amount of false positives in phishing attack detections generated by the signature on the plurality of devices; and
in response to determining that the signature has produced less than the threshold amount of false positives, transmitting a command to each of the plurality of devices to enter the signature in an active mode in which remediation actions can be taken against the potential phishing attacks comprising the signature.
